(19) United States
(12) Patent Application Publication
(10) Pub. No.: US 2022/0304302 A1
(43) Pub. Date: Sep. 29, 2022

(54) MUCILAGE BASED PLANT PROTECTION PRODUCT AND METHOD THEREOF

(71) Applicant: BOTANOHEALTH LTD., JERUSALEM (IL)

(72) Inventors: Yaniv KITRON, JERUSALEM (IL); Amir KITRON, JERUSALEM (IL)

(21) Appl. No.: 17/753,175

(22) PCT Filed: Aug. 20, 2020
(86) PCT No.: PCT/IL2020/050918

§ 371 Date: Feb. 22, 2022

Related U.S. Application Data
(60) Provisional application No. 62/890,084, filed on Aug. 22, 2019.

(51) Int. Cl. A01N 25/04; A01N 25/30; A01P 3/00; A01N 65/22

(52) U.S. Cl. CPC A01N 25/04; A01N 25/30; A01P 3/00; A01N 65/22

(57) ABSTRACT

The present application provides a plant production product, comprising: mucilage, a bio-fungicide and at least one detergent; wherein the composition is effective for the prevention and treatment of plant infections and infestations.

### FIELD OF THE INVENTION

The present invention is in the field of plant and crop protection.

### BACKGROUND OF THE INVENTION

Fungal diseases are major threats to the most important crops upon which humanity depends. All of the critical crops (rice, wheat, maize, potato and soy) are subject to infection by fungal pathogens. The amount of critical crops infected each year by fungal pathogens has been estimated to suffice to feed >8% of the global population.

The current global market for fungicides is $18 billion, with the natural pesticides market estimated at $3 billion. Of the total market, the botrytis pesticides market is a large part at $1.5 billion.

Botrytis is cause of one of main issues in cannabis cultivation (BUD ROT). BUD ROT can cause total destruction of crop within few weeks. The USA does not allow use of chemical pesticides in cannabis cultivation. Any residue detected in consumer product is immediately cause of apprehension and destruction There exists a long-felt need for an efficient method for the protection of crops from fungal pathogens and infections.

### SUMMARY

It is the object of the present invention to provide a plant production product, comprising:
a. mucilage;
b. bio-fungicide; and
c. at least one detergent;
   wherein the composition is effective for the prevention and treatment of plant infections and infestations.

It is another object of the present invention as described above, wherein the composition is characterized as being at least one of the following:
a. environmentally-friendly;
b. non-toxic;
c. long lasting;
d. forming a thin film on the applied surface.

It is another object of the present invention as described above, wherein the thin film or the mucilage is formulated to suffocate said plant pest.

It is another object of the present invention as described above, wherein the mucilage comprises between 0.025% and 0.5% of the composition.

It is another object of the present invention as described above, wherein the bio-fungicide comprises between 0.01 and 0.5% of the composition.

The composition of claim 1, wherein said detergent comprises between 0.1% and 15% of said composition

The product of claim 1, wherein said mucilage comprises compounds selected from a group consisting of saccharides, polysaccharides, exopolysaccharides, sugars, proteins, glycoproteins, lipids, acids, fatty acids, organic acids, pectin, chitosan, aloe gel and xanthene's.

It is another object of the present invention as described above, wherein the compounds are natural, synthetic and/or semisynthetic.

It is another object of the present invention as described above, wherein the composition additionally comprises a polyol

It is another object of the present invention as described above, wherein the polyol is glycine.

It is another object of the present invention as described above, wherein the polyol comprises between 0.1 and 5% of the composition.

It is another object of the present invention as described above, wherein the product is formulated to be applied by a method selected from a group consisting of spraying and washing.

It is another object of the present invention as described above, wherein the surface is selected from a group consisting of plant parts, plant products, buildings and green houses.

It is another object of the present invention as described above, wherein the product is formulated to be applied before or after infection/contamination/contact.

It is another object of the present invention as described above, wherein the plant infestation is caused by a fungus.

It is another object of the present invention as described above, wherein the fungi is selected from a group consisting of Botrytis cinerea, Powdery mildew, alternaria, aspergillus, sclerotina.

It is another object of the present invention as described above, wherein the product is formulated to affect the ability of said pest to breath.

It is another object of the present invention as described above, wherein the composition is characterized by at least one of the following:
a. Viscosity in the range of 100-500 cP;
b. Volatility/boiling point in the range of >50° C.;
c. pH is in the range of 6-9;
d. density is in the range of 0.8-1.2.

It is another object of the present invention as described above, wherein there exist a synergistic effect between the active ingredient and the detergent.

It is the object of the present invention to provide a method for the protection of a plant, comprising steps of:
a. Obtaining the product of claim 1; and
b. Applying said product of claim 1 to a surface to create a thin film layer,
   wherein the thin film layer protects said plant from damage from pests.

It is another object of the present invention as described above, wherein the surface is a part of a plant, the plant part is a leaf, a stem, a flower and a fruit.

It is another object of the present invention as described above, wherein the pest is a fungus.

It is another object of the present invention as described above, wherein the fungi is selected from a group consisting of Botrytis cinerea, Powdery mildew, alternaria, aspergillus, sclerotina.

It is another object of the present invention as described above, wherein the application period is before harvest, post-harvest, before infection or after infection.

It is the object of the present invention to provide a plant production product delivery vehicle/platform, comprising:
a. mucilage;
b. At least one detergent
   wherein the composition is effective for the delivery of a product for the prevention and treatment of plant infections and infestations.

It is another object of the present invention as described above, wherein the composition is characterized as being at least one of the following:
a. environmentally-friendly;
b. non-toxic;
c. long lasting;
d. forming a thin film on the applied surface.

It is another object of the present invention as described above, wherein the thin film or the mucilage if formulated to suffocate the plant pest.

It is another object of the present invention as described above, wherein the mucilage comprises between 0.025% and 0.5% of the composition.

It is another object of the present invention as described above, wherein the detergent comprises between 0.1% and 15% of the composition

It is another object of the present invention as described above, wherein the mucilage comprises compounds selected from a group consisting of saccharides, polysaccharides, exopolysaccharides, sugars, proteins, glycoproteins, lipids, acids, fatty acids, organic acids, pectin, chitosan, aloe gel and xanthene.

It is another object of the present invention as described above, wherein the compounds are natural, synthetic and/or semisynthetic.

It is another object of the present invention as described above, wherein the platform is formulated to be applied by a method selected from a group consisting of spraying, washing.

It is another object of the present invention as described above, wherein the surface is selected from a group consisting of plant parts, plant products, buildings and green houses.

It is another object of the present invention as described above, wherein the product is formulated to be applied before or after infection/contamination/contact.

It is another object of the present invention as described above, wherein the composition is characterized by at least one of the following:
a. Viscosity in the range of 100-500 cP;
b. Volatility/boiling point in the range of >50° C.;
c. pH is in the range of 6-9;
d. density is in the range of 0.8-1.2.

It is another object of the present invention as described above, wherein the composition additionally comprises a polyol It is another object of the present invention as described above, wherein the polyol is glycine.

It is another object of the present invention as described above, wherein the polyol comprises between 0.1 and 5% of the composition.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention wherein:

FIG. 1—shows the effect of thyme oil with and without xanthene on saprophytic growth of B. Cinerea. Potato dextros agar (PDA) plates of various thyme oil, xanthene and control were contaminated with a PDA plug and average colony size was measured after 45 hours.

FIG. 2—shows the effect of thyme oil with and without soap on saprophytic growth of B. cinerea. Potato dextros agar (PDA) plates of various thyme oil, soap and control were contaminated with a PDA plug and average colony size was measured after 45 hours.

FIG. 3—shows the effect of thyme oil on tomato leaf infection incidence. 5 weeks old tomato plants were contaminated with a mixture of 1000 Botrytis spores, 0.1% thyme oil, 0.1% solvent, or PDB. Bars represent the sum of all sites displaying (black bars) or not displaying (white bars) inoculation symptoms, 48 hours (left side) or 72 hours (right side) post inoculation. Inoculation rate is given in red font over the bars.

FIGS. 4 and 5—shows the effect of thyme oil and xanthene on Botrytis infection incidence on tomato leaves. 5 weeks old tomato plants were contaminated with a mixture of 1000 Botrytis spores and 0.01% thyme oil & xanthene, 0.01% xanthene, or PDB. Bars represent the sum of all sites displaying (black bars) or not displaying (white bars) inoculation symptoms, 48 hours (left side) or 72 hours (right side) post inoculation. Inoculation rate is given in red font over the bars.

### DETAILED DESCRIPTION OF THE PREFERRED EMBODIMENT

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

### Detailed Description of an Embodiment of the Invention

In is within the scope of the application to describe a process and device for the protection of plants utilizing plant based fungicides.

This invention deals with a plant production product platform for the delivery of a bio-fungicide.

The present invention of a pre-harvest, effective, environmentally-friendly/benign spray to be applied to leaves as a treatment against fungal contamination with Botrytis. The suggested mechanism is the spray application of a mixture (emulsion) comprised of a mucilage and biofungicide from plant extracts. The coating created by the mucilage on the leaves' surface protects the anti-fungal extracts from rapid evaporation, thus allowing them to work for a longer time against the Botrytis contamination.

Botrytis causes an infection on over 1400 species of plants (Dorby and Lichter, 2004). In viticulture, it is commonly known as “botrytis bunch rot”; in horticulture, it is usually called “grey mould” or “gray mold”. Horticultural crops include vegetables (such as chickpeas, lettuce, broccoli, and beans) and small fruit crops (such as grape, strawberry, and raspberry), these are most severely affected and devastated by gray mold. Plant organs affected include fruits, flowers, leaves, storage organs, and shoots. Green houses have ‘ideal’ conditions for infection: temperature of 20-25° C. and high moisture content.

The term mucilage is used to describe as a thick, gluey substance. In nature, mucilage is secreted by nearly all plants and some microorganisms. In nature the mucilage is a polar glycoprotein and an exopolysaccharide. The Mucilage can comprise organic compounds such as chitosan, aloe, saccharides, polysaccharides, exopolysaccharides, sugars, proteins, glycoproteins, lipids, acids, fatty acids, organic acids, xanthene and xanthene derivatives. These compounds can be from a natural source or synthetic. In some embodiments, the compounds are of a hybrid, semisynthetic, origin.

The product can be diluted in a solution of polyols (such as glycerol) in water

In nature, mucilage in plants plays a role in the storage of water and food, seed germination, and thickening membranes.

In some embodiments, the product can be applied to a plant product (such as a fruit or vegetable), post-harvest, to extend shelf life.

In some embodiment, the product is applied as a spray and wash to create a thin film. The product can be applied to part of the plant (such as leafs) or to surfaces connected to the plant to stop infection.

The applied product for botrytis on the basis of Thyme oil was evaluated and was applied with good results with manual sprayers, at a dose of 10 ml per liter of water, it was observed that it does not stain the fruit and that it is effective at reducing the severity of the Botrytis cinerea. For the application in flower the process is more elaborated and its application is recommended only in living tissues.

### EXAMPLES

The platform was evaluated for plant protection efficacy:
1) The formulation was evaluated for Botrytis cinerea protection in a petri dish:
   i. Botrytis cinerea was grown in a Petri dish on Potato dextrose agar based growth matrix (2% PDA, 0.25 w/v chloramphenicol) in the dark at 18° C.
   ii. Petri dishes where treated with an infected PDA plug and a test dosage:
      i. Positive controls:
         1. Active agent (thyme oil)+Solvent,
         2. Active agent (thyme oil)+Soap,
         3. Active agent (thyme oil)+Xanthene,
      ii. Negative controls:
         1. Solvent,
         2. Soap,
         3. Xanthene
   iii. The fungi infection was measured 3-5 times a day for 3-4 days, post treatment.

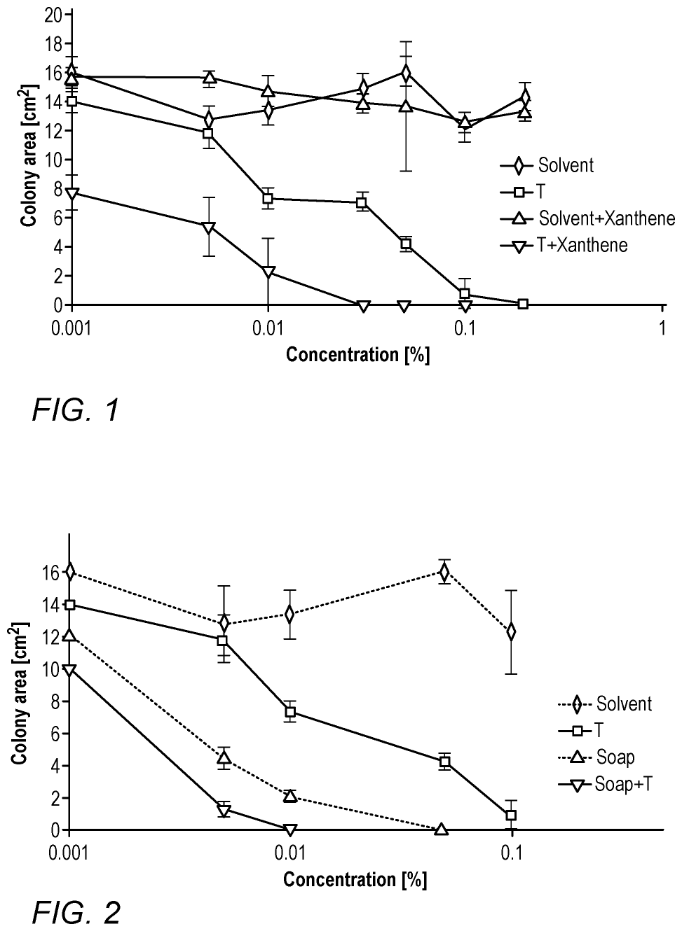

FIG. 1—shows the effect of thyme oil with and without xanthene on saprophytic growth of B. Cinerea. Potato dextros agar (PDA) plates of various thyme oil, xanthene and control were contaminated with a PDA plug and average colony size was measured after 45 hours.

FIG. 2—shows the effect of thyme oil with and without soap on saprophytic growth of B. cinerea. Potato dextros agar (PDA) plates of various thyme oil, soap and control were contaminated with a PDA plug and average colony size was measured after 45 hours. This demonstrated that the soap and xanthene increase the Fungicide ability of thyme oil.
2) The formulation was evaluated for Botrytis cinerea protection on whole tomato plants:
   i. Tomato plants (Brightgate) where obtained at 4 weeks, replanted and acclimatized (22-28° C., 16 hour light).
   ii. Plants where treated with: Active agent thyme oil+Solvent, Thyme oil+soap, T+xanthene, negative controls (Solvent, Soap, xanthene). The plants were treated on 4 leafs, at 6 places on each leaf, with a solution containing 1000 spores. Infected (and non-infected control) plants were preserved in a moist environment.
   iii. Fungi infestation was evaluated every 24 hours for 3 days.

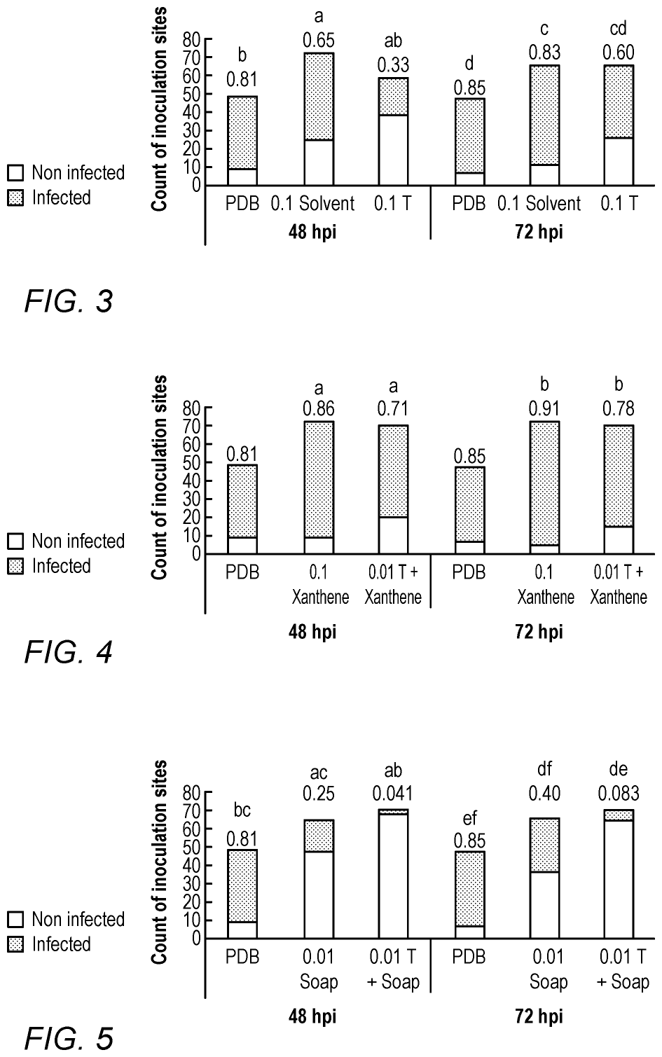

FIG. 3—shows the effect of thyme oil on tomato leaf infection incidence. 5 weeks old tomato plants were contaminated with a mixture of 1000 Botrytis spores, 0.1% thyme oil, 0.1% solvent, or PDB. Bars represent the sum of all sites displaying (black bars) or not displaying (white bars) inoculation symptoms, 48 hours (left side) or 72 hours (right side) post inoculation. Inoculation rate is given in red font over the bars.

FIGS. 4 and 5—show the effect of thyme oil and xanthene on Botrytis infection incidence on tomato leaves. 5 weeks old tomato plants were contaminated with a mixture of 1000 Botrytis spores and 0.01% thyme oil & xanthene, 0.01% xanthene, 0.01% thyme oil & soap. 0.01% soap or PDB. Bars represent the sum of all sites displaying (black bars) or not displaying (white bars) inoculation symptoms, 48 hours (left side) or 72 hours (right side) post inoculation. Inoculation rate is given in red font over the bars.

These experiments demonstrate that the addition of 0.01% soap increases the fungicide ability of active ingredient (thyme oil).
3) The formulation was evaluated for Powdery mildew on whole Bell pepper plants:
   i. Bell pepper plants where obtained at 4 weeks, replanted and acclimatized (22-28° C., 16 hour light).
   ii. Plants where divided between treated plants: present formulation/active agent (thyme oil 0.1%)+Soap, negative control plants (no active fungicide) and a positive control (Penconazole, Ophir 2000). The plants were treated on 4 leafs, at 6 places on each leaf, with a solution containing 1000 spores. Infected plants were preserved in a moist environment.
   iii. Fungi infestation was evaluated every 24 hours for 3 days:
      i. Treated: 55% of leafs where infected;
      ii. Negative control: 97.5 of leafs where infected
      iii. Positive control: 40% of leafs where infected

This experiment demonstrates that the formulation of the present invention has an anti-fungicide activity similar to that of synthetic fungicides.

1. A plant production product, comprising:
a. mucilage;
b. bio-fungicide; and
c. at least one detergent;
wherein said composition is effective for the prevention and treatment of plant infections and infestations.

2. The product of claim 1, wherein said composition is characterized as being at least one of the following:
a. environmentally-friendly;
b. non-toxic;
c. long lasting;
d. forming a thin film on the applied surface.

3. The product of claim 1 or 2, wherein said thin film or said mucilage if formulated to suffocate said plant pest.

4. The product of claim 1, wherein said mucilage comprises between 0.025% and 0.5% of said composition.

5. The product of claim 1, wherein said bio-fungicide comprises between 0.01 and 0.5% of said composition.

6. The composition of claim 1, wherein said detergent comprises between 0.1% and 15% of said composition.

7. The product of claim 1, wherein said mucilage comprises compounds selected from a group consisting of saccharides, polysaccharides, exopolysaccharides, sugars, proteins, glycoproteins, lipids, acids, fatty acids, organic acids, pectin, chitosan, aloe gel and xanthene's.

8. The product of claim 5, wherein said compounds are natural, synthetic and/or semisynthetic.

9. The product of claim 1, wherein said composition additionally comprises a polyol

10. The product of claim 9, wherein said polyol is glycine.

11. The product of claim 9, wherein said polyol comprises between 0.1 and 5% of said composition.

12. The product of claim 1, wherein said product is formulated to be applied by a method selected from a group consisting of spraying and washing.

13. The product of claim 12, wherein said surface is selected from a group consisting of plant parts, plant products, buildings and green houses.

14. The product of claim 1, wherein said product is formulated to be applied before or after infection/contamination/contact.

15. The product of claim 1, wherein said plant infestation is caused by a fungus.

16. The product of claim 15, wherein said fungi is selected from a group consisting of Botrytis cinerea, Powdery mildew, alternaria, aspergillus, selerotina.

17. The product of claim 1, wherein said product is formulated to affect the ability of said pest to breath.

18. The product of claim 1, wherein said composition is characterized by at least one of the following:
a. Viscosity in the range of 100-500 cP;
b. Volatility/boiling point in the range of >50° C.;
c. pH is in the range of 6-9;
d. density is in the range of 0.8-1.2.

19. the product of claim 1, wherein there exist a synergistic effect between said active ingredient and said detergent.

20. A method for the protection of a plant, comprising steps of:
a. Obtaining the product of claim 1; and
b. Applying said product of claim 1 to a surface to create a thin film layer,
wherein said thin film layer protects said plant from damage from pests.

21. The method of claim 20, wherein said surface is a part of a plant, said plant part is a leaf, a stem, a flower and a fruit.

22. The method of claim 20, wherein said pest is a fungus.

23. The method of claim 22, wherein said fungi is selected from a group consisting of Botrytis cinerea, Powdery mildew, alternaria, aspergillus, sclerotina.

24. The method of claim 20, wherein said application period is before harvest, post-harvest, before infection or after infection.

25. A plant production product delivery vehicle/platform, comprising:
a. mucilage;
b. At least one detergent
wherein said composition is effective for the delivery of a product for the prevention and treatment of plant infections and infestations.

26. The product of claim 25, wherein said composition is characterized as being at least one of the following:
a. environmentally-friendly;
b. non-toxic;
c. long lasting;
d. forming a thin film on the applied surface.

27. The product of claim 25 or 26, wherein said thin film or said mucilage if formulated to suffocate said plant pest.

28. The product of claim 25, wherein said mucilage comprises between 0.025% and 0.5% of said composition.

29. The composition of claim 25, wherein said detergent comprises between 0.1% and 15% of said composition

30. The product of claim 25, wherein said mucilage comprises compounds selected from a group consisting of saccharides, polysaccharides, exopolysaccharides, sugars, proteins, glycoproteins, lipids, acids, fatty acids, organic acids, pectin, chitosan, aloe gel and xanthene.

31. The product of claim 30, wherein said compounds are natural, synthetic and/or semisynthetic.

32. The product of claim 25, wherein said platform is formulated to be applied by a method selected from a group consisting of spraying, washing.

33. The product of claim 25, wherein said surface is selected from a group consisting of plant parts, plant products, buildings and green houses.

34. The product of claim 25, wherein said product is formulated to be applied before or after infection/contamination/contact.

35. The product of claim 25, wherein said composition is characterized by at least one of the following:
a. Viscosity in the range of 100-500 cP;
b. Volatility/boiling point in the range of >50° C.;
c. pH is in the range of 6-9;
d. density is in the range of 0.8-1.2.

36. The product of claim 25, wherein said composition additionally comprises a polyol

37. The product of claim 36, wherein said polyol is glycine.

38. The product of claim 36, wherein said polyol comprises between 0.1 and 5% of said composition.
